(19) United States
(12) Patent Application Publication
(10) Pub. No.: US 2006/0136704 A1
(43) Pub. Date: Jun. 22, 2006

(54) System and method for selectively installing an operating system to be remotely booted within a storage area network

(75) Inventors: James Wendell Arendt, Austin, TX (US); Gregory Brian Pruett, Raleigh, NC (US); Ziv Rafalovich, Yokneam IIit (IL); David B. Rhoades, Raleigh, NC (US); Linda Ann Riedle, Cary, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/016,227

(22) Filed: Dec. 17, 2004

(51) Int. Cl. G06F 9/24

(52) U.S. Cl. 713/2

(57) ABSTRACT

A management computer controlling operations of computer systems in a number of positions within a chassis is programmed to receive a signal indicating that one of the computer systems has been installed and to determine whether it has been installed in a previously unoccupied position, installed in a previously occupied position, or moved from one position to another. If it has been installed in a previously unoccupied position, an operating system is installed for remote booting; if it has been installed in a previously occupied position, it is allowed to continue booting the operating system used by the computer it replaced; if it has been moved from one position to another, it is allowed to continue booting as before.

### BACKGROUND OF THE INVENTION

1. Field of the Invention

This invention relates to installing an operating system to be remotely booted by a computer system within a storage area network, and, more particularly, to selectively installing an operating system to be remotely booted by a computer system installed within a chassis having a number of positions for holding computer systems, so that such an operating system is installed for use by computer system installed in a previously unoccupied position, while a computer system replacing a previously installed computer is provided with a means to continue booting the operating system used by the previously installed computer.

2. Summary of the Background Art

To an increasing extent, computer systems are built within small, vertically oriented housings as server blades for attachment within a chassis. For example, the IBM BladeCenter™ is a chassis providing slots for fourteen server blades. Within the chassis, electrical connections to each server blade are made at the rear of the server blade as the server blade is pushed into place within the slot. Levers mounted in the server blade to engage surfaces of the chassis are used to help establish the forces necessary to engage the electrical connections as the server blade is installed, and to disengage the connections as the server blade is subsequently removed. Thus, it is particularly easy to remove and replace a server blade within a chassis.

Data storage may be provided to various server blades via local drives installed on the blades. Such an arrangement can be used to deploy an operating system to the server blades in an initial deployment process, with the operating system then being stored within the local hard disk drive of each server blade for use in operating the server blade. With such an arrangement, a detect-and-deploy process can be established to provide for the deployment of the operating system to a new server blade that has been detected as replacing a server blade to which the operating system has previously been deployed. The process for deploying the operating system to the replacement server blade is then identical to the process for initially deploying the operating system to a server blade as the configuration of the server chassis is first established.

Alternatively, the individual server blades are not provided with local disk drives, with magnetic data storage being provided only through the remote storage server, which is connected to the server blades through a storage area network (SAN). In the absence of local magnetic data storage, the operating system must be booted to each server blade from the remote storage server.

For example, the SAN may be established through a Fibre Channel networking architecture, which establishes a connection between the chassis and the remote storage server. The Fibre Channel standards define a multilayered architecture that supports the transmission of data at high rates over both fiber-optic and copper cabling, with the identity of devices attached to the network being maintained through a hierarchy of fixed names and assigned address identifiers, and with data being transmitted as block Small Computer System Interface (SCSI) data. Each device communicating on the network is called a node, which is assigned a fixed 8-byte node name by its manufacturer. Preferably, the manufacturer has derived the node name from a list registered with the IEEE, so that the name, being globally unique, is referred to as a World-Wide Name (WWN). For example, a SAN may be established to include a number of server blades within a chassis, with each of the server blades having a host bus adapter providing one or more ports, each of which has its own WWN, and a storage server having a controller providing one or more ports, each of which has its own WWN. The storage resources accessed through the storage server are then shared among the server blades, with the resources that can be accessed by each individual server blade being further identified as a SCSI logical unit with a logical unit name (LUN). It is often desirable to prevent the server blades from accessing the same logical units of storage, for security, and also because it is desirable to prevent one server blade from inadvertently writing over the data of another server blade. Zoning may also be enabled at a switching position within the SAN, to provide an additional level of security in ensuring that each server blade can only access data within storage servers identified by one or more WWNs.

As many as three links must be established before one of the server blades can access data identified with the LUN through the remote storage server. First, in the remote storage server, the LUN must be mapped to the WWN of the host bus adapter within the server blade. Then, if the data being accessed is required for the process of booting the server blade, the HBA BIOS within the server blade must be set to boot from the WWN and LUN of the storage server. Additionally, if zoning is enabled to establish security within a switch in the fibre network, a zoning entry must be set up to include the WWN of the storage server and the WWN of the host bus adapter of the server blade.

Thus, to replace a server blade without local storage attached to a SAN through a Fibre Channel having a detect-and-deploy policy, the user must first open a management application to delete the detect-and-deploy policy for the server blade being replaced, since it will be no longer necessary to deploy the operating system to the new server blade, which can be expected to then used the operating system previously deployed to the server blade being replaced. Then, the old server blade is removed, and the new server blade is inserted. The storage server is reconfigured with the WWNs of the new blade's fibre HBA and the fibre switch zone is changed to use the WWNs of the new blade's fibre HBA in place of the ones associated with the old blade. Then, the new server blade is turned on, and the user opens and enables the BIOS and configures the boot setting of the host bus adapter connecting the blade to the Fibre Channel.

The October, 2001, issue of Research Disclosure describes, on page 1759, a method for automatically configuring a server blade environment using its positional deployment in the implementation of the detect-and-deploy process. A particular persona is deployed to a server based on its physical position within a rack or chassis. The persona information includes the operating system and runtime software, boot characteristics, and firmware. By assigning a particular persona to a position within the chassis, the user can be assured that any general purpose server blade at that position will perform the assigned function. All of the persona information is stored remotely on a Deployment Server and can be pushed to a particular server whenever it boots to the network. On power up, each server blade reads the slot location and chassis identification from the pins on the backplane. This information is read by the system BIOS and stored in a physical memory table, which can be read by the software. The system BIOS will then boot from the network and will execute a boot image from the Deployment Server, which contains hardware detection software routines that gather data to uniquely identify this server hardware, such as the unique ID for the network interface card (NIC). Server-side hardware detection routines communicate with the Bladecenter management module to read the position of the server within the chassis and report information about the location back to the Deployment Server, which uses the obtained information to determine whether a new server is installed at the physical slot position. To determine if a new server is installed, it checks to see whether the unique NIC ID for the particular slot has changed since the last hardware scan operation. In the event that it detects a newly installed server in an unassigned slot position, the Deployment Server will send additional instructions to the new server indicating how to boot the appropriate operating system and runtime software as well as other operations to cause the new server to assume the persona of the previously installed server. This mechanism allows customers to create deployment policies that allow a server to be replaced or upgraded with new hardware while maintaining identical operational function as before. When a server is replaced, it can automatically be redeployed with the same operating system and software that was installed on the previous blade, minimizing customer downtime. While this method provides for the replacement of a server blade having a local hard file, to which the operating system is deployed from the Deployment Server, what is needed is a method providing for the replacement of a server blade without a local hard file, which operates with an operating system deployed to a logical drive within a remote storage server.

The October, 2001 issue of Research Disclosure further describes, on page 1776, a method for automatically configuring static network addresses in a server blade environment, with fixed, predetermined network settings being assigned to operating systems running on server blades. This method includes an integrated hardware configuration that combines a network switch, a management processor, and multiple server blades into a single chassis which shares a common network interconnect. This hardware configuration is combined with firmware on the management processor to create an automatic method for assigning fixed, predetermined network settings to each of the server blades. The network configuration logic is embedded into the management processor firmware. The management processor has knowledge of each of the server blades in the chassis, its physical slot location, and a unique ID identifying its network interface card (NIC). The management processor allocates network settings to each of the blades based on physical slot position, ensuring that each blade always receives the same network settings. The management processor then responds to requests from the server blades using the Dynamic Host Configuration Protocol (DHCP). Because network settings are automatically configured by the server blade environment itself, no special deployment routine is required to configure static network settings on the blades. Each server blade can be installed with an identical copy of an operating system, with each operating system configured to dynamically retrieve network settings using the DHCP protocol.

The patent literature describes a number of methods for transmitting data to multiple interconnected computer systems, such as server blades. For example, U.S, Pat. App. Pub. No. 2003/0226004 A1 describes a method and system for storing and configuring CMOS setting information remotely in a server blade environment. The system includes a management module configured to act as a service processor to a data processing configuration.

The patent literature further describes a number of methods for managing the performance of a number of interconnected computer systems. For example, U.S, Pat. App. Pub. No. 2004/0030773 A1 describes a system and method for managing the performance of a system of computer blades in which a management blade, having identified one or more individual blades in a chassis, automatically determines an optimal performance configuration for each of the individual blades and provides information about the determined optimal performance configuration for each of the individual blades to a service manager. Within the service manager, the information about the determined optimal performance configuration is processed, and an individual frequency is set for at least one of the individual blades using the information processed within the service manager.

U.S, Pat. App. Pub. No. 2004/0054780 A1 describes a system and method for automatically allocating computer resources of a rack-and-blade computer assembly. The method includes receiving server performance information from an application server pool disposed in a rack of the rack-and-blade computer assembly, and determining at least one quality of service attribute for the application server pool. If this attribute is below a standard, a server blade is allocated from a free server pool for use by the application server pool. On the other hand, if this attribute is above another standard, at least one server is removed from the server pool.

U.S, Pat. App. Pub. No. 2004/0024831 A1 describes a system including a number of server blades, at least two management blades, and a middle interface. The two management blades become a master management blade and a slave management blade, with the master management blade directly controlling the system and with the slave management controller being prepared to control the system. The middle interface installs server blades, switch blades, and the management blades according to an actual request. The system can directly exchange the master management blade and slave management blades by way of application software, with the slave management blade being promoted to master management immediately when the original master management blade fails to work.

U.S, Pat. App. Pub. No. 2003/0105904 A1 describes a system and method for monitoring server blades in a system that may include a chassis having a plurality of racks configured to receive a server blade and a management blade configured to monitor service processors within the server blades. Upon installation, a new blade identifies itself by its physical slot position within the chassis and by blade characteristics needed to uniquely identify and power the blade. The software may then configure a functional boot image on the blade and initiate an installation of an operating system. In response to a power-on or system reset event, the local blade service processor reads slot location and chassis identification information and determines from a tamper lock whether the blade has been removed from the chassis since the last power-on reset. If the tamper latch is broken, indicating that the blade was removed, the local service processor informs the management blade and resets the tamper latch. The local service processor of each blade may send a periodic heartbeat message to the management blade. The management blade monitors the loss of the heartbeat signal from the various local blades, and then is also able to determine when a blade is removed.

U.S, Pat. App. Pub. No. 2004/0098532 A1 describes a blade server system with an integrated keyboard, video monitor, and mouse (KVM) switch. The blade server system has a chassis, a management board, a plurality of blade servers, and an output port. Each of the blade servers has a decoder, a switch, a select button, and a processor. The decoder receives encoded data from the management board and decodes the encoded data to command information when one of the blade servers is selected. The switch receives the command information and is switched according to the command information.

### SUMMARY OF THE INVENTION

It is a first objective of the invention to install an operating system to be remotely booted by a computer system installed within a storage area network in a previously unoccupied computer receiving position within a chassis having a number of computer receiving positions.

It is a second objective of the invention to provide for a computer system installed within a storage area network in the replacement of a computer system remotely booting an operating system to continue booting the same operating system.

It is a third objective of the invention to provide for a computer system moved from one computer receiving position to another to continue booting the same operating system.

In accordance with one aspect of the invention, a system including a chassis, first and second networks, a storage server, and a management server is provided. The chassis, which includes a number of computer system receiving positions, generates a signal indicating that a computer system is installed in one of the computer receiving positions. The storage server provides access to remote data storage over the first network from each of the computer receiving positions. The management server, which is connected to the chassis and to the storage server over the second network, is programmed to perform a method including steps of:
receiving a signal indicating that a recently installed computer system has been installed in a first position within the plurality of computer receiving positions;
determining whether the first position has previously been occupied by a formerly installed computer system;
in response to determining that the first position has not previously been occupied by a formerly installed computer system, installing the operating system in a storage location within the remote data storage to be accessed by the recently installed computer system and establishing a path for communications between the recently installed computer system and the storage location within the remote data storage; and
in response to determining that the first position has previously been occupied by a formerly installed computer system, establishing a path for communications between the recently installed computer system and a location for storage within the remote data storage accessed by the formerly installed computer system.

The path for communications between the recently installed computer and the storage location may be established by writing information over the second network describing the storage location to the recently installed computer system and by writing information over the second network describing the recently installed computer system to the storage server. The path for communication between the recently installed computer system and the location for storage accessed by the formerly installed computer system may be established by writing information over the second network describing the recently installed computer system to the storage server. For example, if the first network includes a Fiber Channel, the information describing the storage location includes a logical unit number (LUN), and the information describing the recently installed computer system includes a world wide name (WWN).

The method performed by the management server may also include determining whether the recently installed computer system has been previously installed in another of the computer receiving positions to access a previous location for storage within the remote data storage. Then, in response to determining that the recently installed computer system has been previously installed in another of the computer receiving positions to access the previous location for storage, the path for communication between the recently installed computer system and the previous location for storage is not changed.

### BRIEF DESCRIPTION OF THE DRAWINGS

FIG. 1 is a block diagram of a system configured in accordance with the invention;

FIG. 2 is a pictographic view of a data structure stored within the data and instruction storage of a management server within the system of FIG. 1;

FIG. 3, which is divided into an upper portion, indicated as FIG. 3A, and a lower portion, indicated as 3B, is a flow chart of process steps occurring during the execution of a remote deployment application within the processor of the management server within the system of FIG. 1;

FIG. 4 is a flow chart of processes occurring within a computer system in the system of FIG. 1 during a system initialization process following power on;

FIG. 5 is a flow chart of processes occurring during execution of a replacement task scheduled for execution by the remote deployment application program of FIG. 3; and

FIG. 6 is a flow chart of processes occurring during execution of a deployment task scheduled for execution by the remote deployment application program of FIG. 3

### DETAILED DESCRIPTION OF THE INVENTION

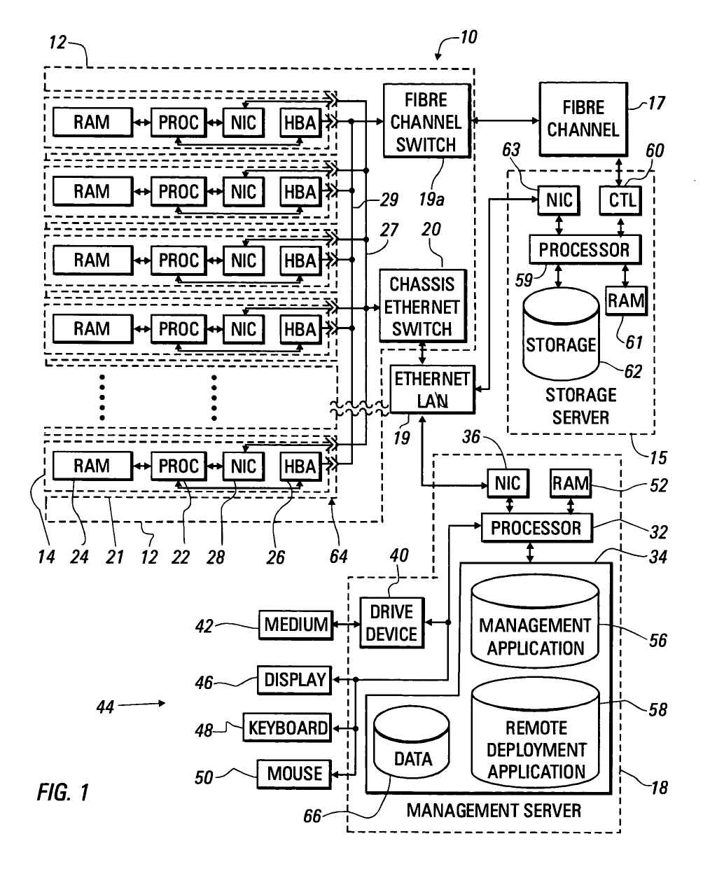

FIG. 1 is a block diagram of a system 10 configured in accordance with the invention. The system 10 includes a chassis 12, holding a number of computer systems 14, a remote storage server 15, connected to communicate with each of the computer systems 14 over a first network 17, and a management server 18, connected to communicate with each of the computer systems 14 over a second network 19. In particular, the computer systems 14 share disk data storage resources provided by the storage server 15, with operations being controlled by the management server 18 in a manner providing for the continued operation of the system 10 when one of the computer systems 14 is replaced.

Preferably, the first network 17 is a Fibre Channel, connected to each of the computer systems 14 through a Fibre Channel switch 19a within the chassis 12, while the second network 19 is an Ethernet LAN (local area network) connected with each of the computer systems 14 through a chassis Ethernet switch 20. For example, the chassis 12 is an IBM BladeCenter™ having fourteen individual computer receiving positions 21, each of which holds a single computer system 14. Each of the computer systems 14 includes a microprocessor 22, random access memory 24 and a host bus adapter 26, which is connected to the Fibre Channel switch 19a by means of a first internal network 29. Each of the computer systems 14 also includes a network interface circuit 28, which is connected to the chassis Ethernet switch 20 through a second internal network 27.

The management server 18 includes a processor 32, data and instruction storage 34, and a network interface circuit 36, which is connected to the Ethernet LAN 19. The management server 18 also includes a drive device 40 reading data from a computer readable medium 42, which may be an optical disk, and a user interface 44 including a display screen 46, and selection devices, such as a keyboard 48 and a mouse 50. The remote storage server 18 further includes a random access memory 52, into which program instructions are loaded for execution within the microprocessor 32, together with data and instruction storage 34, which is preferably embodied on non-volatile media, such as magnetic media. For example, data and instruction storage 34 stores instructions for a management application 56, for controlling various operations of the computer systems 14, and a remote deployment application 58, which is called by the management application 56 when a computer system 14 is installed within the chassis 12. Program instructions for execution within the processor 32 may be loaded into the remote storage server 18 in the form of computer readable information on the computer readable medium 42, to be stored on another computer readable medium within the data and instruction storage 34. Alternately, program instructions for execution within the processor 32 may be transmitted to the management server 18 in the form of a computer data signal embodied on a modulated carrier wave transmitted over the Ethernet LAN 19.

The remote storage server 15 includes a processor 59, which is connected to the Fibre Channel 17 through a controller 60, random access memory 61, and physical/logical drives providing data and instruction storage 62, which stores instructions and data to be shared among the computer systems 14. The processor 59 is additionally connected to the Ethernet LAN 19 through a network interface circuit 63.

Within each of the computer systems 14, program instructions are loaded into random access storage 24 for execution within the associated microprocessor 22. However, the computer systems 14 each lack high-capacity non-volatile storage for data and instructions, relying instead on sharing the data and instruction storage 62, accessed through the remote storage server 15, from which an operating system is downloaded.

A storage area network (SAN) is formed, with each of the computer systems 14 accessing a separate portion of the data and instruction storage 62 through the Fibre Channel 17, and with this separate portion being identified by a particular logical unit number (LUN). In this way, each of the computer systems 14 is mapped to a logical unit, identified by the LUN, within the data and instruction storage 62, with only one computer system 14 being allowed to access each of the logical units, under the control of the Fibre Channel switch 19a. Within the computer system 14, the host bus adapter 26 is programmed to access only the logical unit within data and instruction storage 62 identified by the LUN, while, within the storage server 15, the controller 60 is programmed to only allow access to this logical unit through the host bus adapter 26 having a particular WWN. Optionally, zoning may additionally be employed within the Fibre Channel switch 19a, with the WWN of the host bus adapter 26 being zoned for access only to the storage server 15.

While the system 10 is shown as including a single chassis 12 communicating with a single storage server 15 over a Fibre Channel 17, it is understood that this is only an exemplary system configuration, and that the invention can be applied within a SAN including a number of chasses 12 communicating with a number of storage servers 15 over a network fabric including, for example, Fibre Channel over the Internet Protocol (FC/IP) links.

The configuration of the chassis 12 makes it particularly easy to replace a computer system 14, in the event of the failure of the computer system 14 or when it is determined that an upgrade or other change is needed. The computer system 14 being replaced is pulled outward and replaced with another computer system 14 slid into place within the associated position 21 of the chassis 12. Electrical connections are broken and re-established at connectors 64 within the chassis 12. When a user inserts a computer system 14 into one of the positions 21, an insertion signal is generated and transmitted over the Ethernet LAN 19 to the management server 18. Operating in accordance with the present invention, the remote deployment application 58 additionally provides support for the replacement of a computer system 14, and for continued operation of the chassis 12 with the new computer system 14.

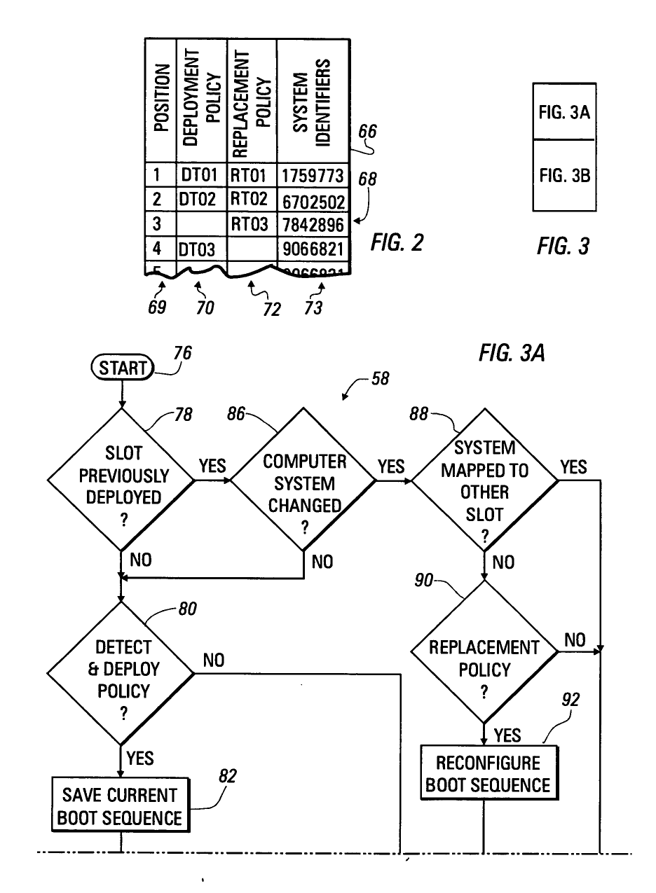

FIG. 2 is a pictographic view of a data structure 66, stored within the data and instruction storage 34 of the management server 16. The data structure 66 includes a data record 68 for each position 21 in which a computer system 14 may be placed, with each of these data records 68 including a first data field 69 storing information identifying the position 21, a second data field 70 storing a name of a deployment policy task, if any, stored for the position 21, a third data field 72 storing a name of a replacement policy task, if any, stored for the position 21, and a fourth data field 73 storing data identifying the computer system 14 within the position 21 identified in the first data field 69. The deployment policy bit within the second data field 70 is set to indicate that an instance of an operating system stored within the data storage 54 should be downloaded to a computer system 14 when the computer system 14 is installed within the position 21 for the first time. For example, “DT1” may identify a task known as “Windows SAN Deployment Task 1,” while “RT1” identifies a task known as “Windows SAN Replacement Task 1.” Names identifying these tasks are stored in data locations corresponding to the individual positions 21 to indicate what should be done if it is determined that a computer system 14 is placed in this position 21 for the first time or if it is determined that the computer system 14 has been replaced.

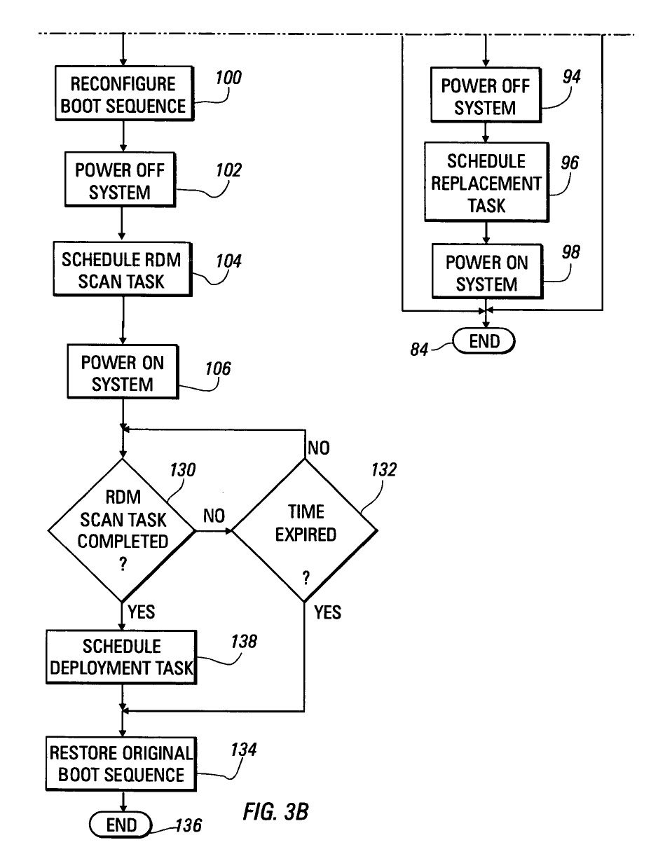

FIG. 3 is a flow chart of process steps occurring during execution of the remote deployment application 58 within the processor 32 of the management server 18. This application 58 is called to start in step 76 by the management application 56 in response to receiving an insertion signal indicating that a computer system 14 has been inserted within one of the positions 21. This application 58 then proceeds to determine whether a previously installed computer system 14 has been returned to its previous position 21 or to another position 21, or whether a new computer system 14 has been installed to replace another computer system 14 or to occupy a previously empty position 21. First, in step 78, a determination is made of whether a computer system 14 has been previously deployed in the position 21 from which the insertion signal originated. For example, such a determination may be made by examining the fourth data field 73 for this position 21 within the data structure 66 to determine whether data has been previously written for such a system. If no computer system 14 has previously been deployed in this position 21, such a computer system 14 is not being replaced, so a further determination is made in step 80, by reading the data stored in data field 70 of the data structure 66 for this position 21, of whether the detect and deploy policy is in effect for this position 21. If it is, the application 58 proceeds to step 82 to begin the process of deploying, or loading, the operating system to the computer system 14 that has just been installed in the position 21. If it is determined in step 80 that the detect and deploy policy is not in effect for this position 21, the remote deployment application 58 ends in step 84, returning to the management application 56.

On the other hand, if it is determined in step 78 that the position 21 has been previously occupied, the remote deployment application 58 proceeds to step 86, in which a further determination is made of whether the computer system 14 in this position 21 has been changed. For example, this determination is made by comparing data identifying the computer system 14 that has just been installed within the position 21 with the data stored in the fourth data field 72 of the data structure 66 to describe a previously installed computer system 14. If it has not, i.e., if the computer system 14 previously within the position 21 has not been replaced, but merely returned to its previous position, the application 58 also proceeds to step 80.

If it is determined in step 86 that the computer system 14 in the position 21 has been replaced, a further determination is made in step 88 of whether the computer system 14 has been mapped to another position 21. For example, this determination is made by comparing information identifying the computer system 14 that has just been installed within information previously stored within the data field 73 for other positions 21. If it has been mapped to another position 21, since the user has apparently merely rearranged the computer system 14 within the chassis 12, there appears to be no need to change the function of the computer system, so the application 58 ends in step 84, returning to the management application 56. In this way, the computer system 14 remains mapped to the logical unit within the data and instruction storage 62 to which it was previously mapped.

On the other hand, if it is determined in step 88 that the computer system 14 that has just been installed has not been mapped to another position 21, a further determination is made in step 90, by reading the data stored in the data structure 66 for this position 21, of whether the replacement policy is in effect for this position 21. If it is not, the application 58 ends in step 84. If it is, the application 58 proceeds to step 92 to begin the process of performing the replacement policy by reconfiguring the boot sequence of the computer system 14, which has been determined to be a replacement system, so that the computer system 14 will boot its operating system from the magement server 18. Then, in step 94, the power is turned off the computer system 14. In step 96, a replacement task is scheduled for the computer system 14 to be executed by the management application 56 running within the management server 18.

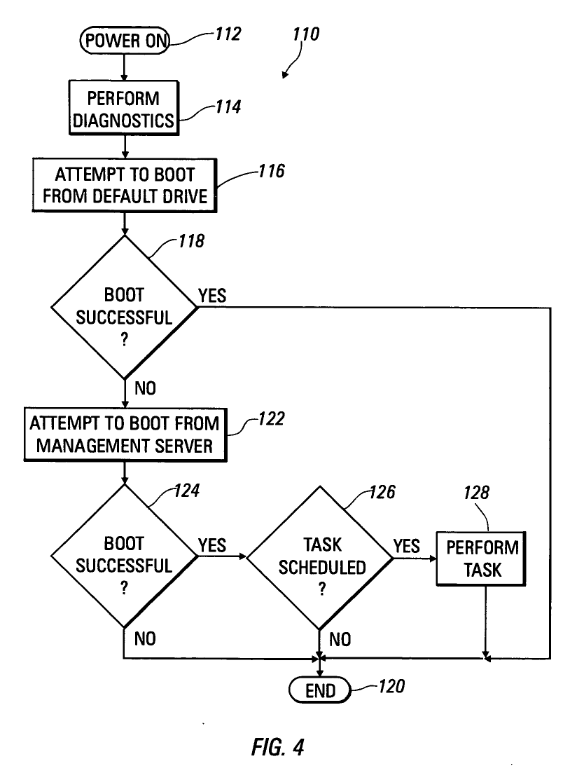

If it is determined in step 80 that the detect and deploy policy is in place for the position of the computer system 14, the application 58 proceeds to step 82, in which the current boot sequence of the computer system 14 is read and saved within RAM 52 or data and instruction storage 34 of the management server 18, so that this current boot sequence can later be restored within the computer system 14. Then, in step 100, the boot sequence of the computer system 14 is reconfigured so that the system 14 will boot from a default drive first and network second, in a manner explained below in reference to FIG. 4. Next, in step 102, power to the computer system 14 is turned off. In step 104, a remote deployment management scan task is scheduled for the computer system 14. Next, in step 106, the computer system 14 is powered on.

FIG. 4 is a flow chart of processes occurring within the computer system 14 during a system initialization process 110 following power on in step 112. First, in step 114, diagnostics are performed by the computer system 14, under control of system BIOS. Next, in step 116, an attempt is made to boot an operating system from the default drive of the computer system 14. If remote booting of the system 14 has been enabled, with the LUN of a portion of the data and instruction storage 62 of the remote storage server 15 being stored within the host bus adapter 26 of the system 14, the default drive is this portion of the data and instruction storage 62. Otherwise, the default drive is a local drive, if any, within the system 14. If the attempt to boot an operating system is successful, as then determined in step 118, the initialization process 110 is completed, ending in step 120 with the system ready to continue operations using the operating system.

On the other hand, the attempt to boot an operating system in step 116 will be unsuccessful if remote booting has not been enabled within the computing system 14, and additionally if a local drive is not present within the system 14, or if such a local drive, while being present, does not store an instance of an operating system. Therefore, if it is determined in step 118 that this attempt to boot an operating system has not been successful, the initialization process 110 proceeds to step 122, in which an attempt is made to boot an operating system from the management server 18 over the Ethernet LAN 19. An operating system, which may be of a different type, such as a DOS operating system instead of a WINDOWS operating system, is stored within data and instruction storage 34 of the management server 18 for this process, which is called “PXE booting.” If it is then determined in step 124 that the attempt to boot an operating system from the management server 18 is successful, the initialization process 110 proceeds to step 126, in which a further determination is made of whether a task has been scheduled for the computer system 14. If it has, instructions for the task are read from the data and instruction storage 34 or RAM 52 of the management server 18, with the task being performed in step 128, before the initialization process ends in step 120. If it is determined in step 124 that the attempt to boot an operating system from the management server 18 has not been successful, the initialization process ends in step 120 without booting an operating system.

Referring to FIGS. 3 and 4, during the remote deployment application 58, when power is restored in step 106 to the computer system 14 that has just been installed, the initialization process begins in step 112. After it is determined in step 118 of the initialization process 110 that remote booting of the system 14 from the data and instruction storage 62 has not been enabled, the completion of the redeployment management scan task scheduled in step 104 is used to provide an indication that deployment of an operating system is needed. Specifically, if the system 14 has a local drive from which an operating system is successfully loaded, it is unnecessary to deploy an instance of the operating system to a portion of the data and instruction storage 62 that will be used by the system 14. On the other hand, if the system 14 does not include a local drive, or if its local drive does not store the operating system, an instance of the operating system is deployed, being installed within the portion of the data and instruction storage 62 that will be used by the system 14.

Thus, following step 106, a determination is made of whether the remote deployment management scan task is completed, as determined in step 130 before a preset time expires, as determined in step 132. This preset time is long enough to assure that the scan task can be completed in step 128 of the initialization process 110 if this step 128 is begun. An indication of the completion of the scan task by the computer system 14 that has just been installed is sent from this system 14 to the management system in the form of a code generated during operation of the scan task.

When it is determined in step 132 that the time has expired without completing the scan task, it is understood that an attempt by the system 14 to boot from its hard drive in step 116 has proven to be successful, in step 118, so that the initialization process 110 has ended in step 120 without performing the scan task in step 128. There is therefore no need to deploy an instance of the operating system for the computer system 14, which is allowed to continue using the operating system already installed on its hard drive, after the original boot sequence, which has previously been saved in step 82, is restored in step 134, with the remote deployment application then ending in step 136.

On the other hand, when it is determined in step 130 that the scan task has been completed before the time has expired, it is understood that the attempt to boot from a default drive in step 116 was determined to be unsuccessful in step 118, with the computer system 14 then booting in step 122 before performing the scan task in step 128. Therefore, the computer system 14 must either not have a hard drive, or the hard drive must not have an instance of an operating system installed thereon. In either case, an instance of the operating system must be deployed to a portion of the data and instruction storage 62 that is to be used by the computer system 14, so a deployment task is scheduled in step 138. Then, the original boot sequence is restored in step 134, with the remote deployment application 58 ending in step 136.

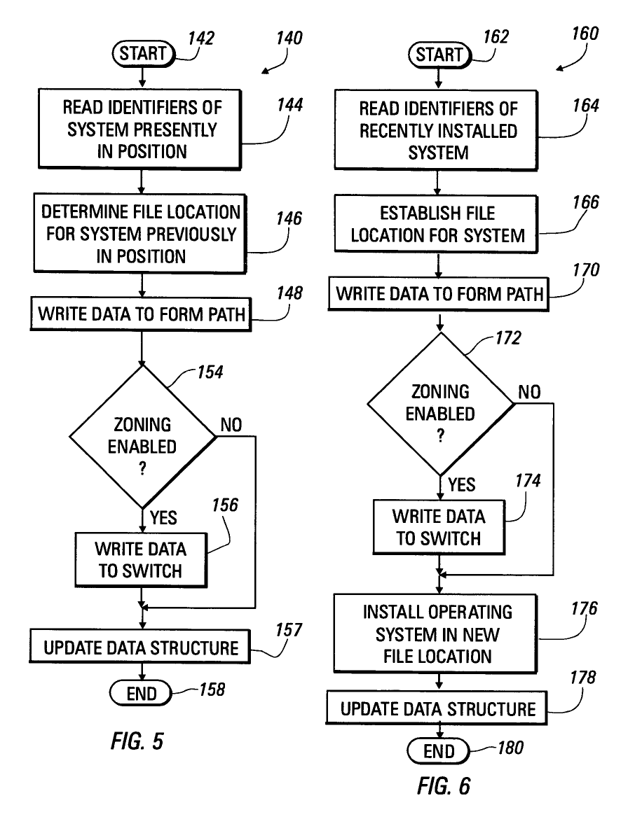

FIG. 5 is a flow chart of processes occurring during execution of the replacement task 140 scheduled for execution by the management server 18 in step 96 of the remote deployment application 58. After starting in step 142, the replacement task 140 proceeds to step 144, in which the information identifying the computer system 14 that has just been installed is read. For example, the world-wide name (WWN) of the host bus adapter 26 within the computer system 14 is read for use in establishing a path through the Fibre Channel 17 to the storage server 15. Next, in step 146, the location of storage within data and instruction storage 62 used by the computer system previously occupying the position 21 in which the computer system 14 has just been installed is found. For example, this is done by reading the fourth data field 73 within the data structure 66 to determine the identifier, such as the WWN of the computer system previously installed within this position 21, and by then querying the controller 60 of the storage server 16 to determine the LUN identifying this storage location within the data and instruction storage 62.

Next, in step 148, the information read in steps 144 and 146 is written to various locations to form a path between the computer system 14 that has just been installed and the portion of the data and instruction storage 62 used by the computer system previously in the slot. For example, the WWN of the controller 60 of the storage server 15 and the LUN of this portion of the data and instruction storage 62 are written to the host bus adapter 26 of the computer system 14, while the WWN of this host bus adapter 26 is written to controller 60 of the storage server 15.

Zoning may be implemented within the Fibre Channel Switch 19a to aid in preventing the use by any of the computer systems 14 of portions of the data and instruction storage 62 that are not assigned to the particular computer system 14. Thus, in step 154, a determination is made of whether zoning is enabled. If it is, in step 156, a zoning entry is written to the Fibre Channel Switch 19a including the WWN of the host bus adapter 26 of the computer system 14, the WWN of the controller 60 of the storage server 15, and the portion of the data and instruction storage 62 assigned to the system 14. In either case, in step 157, the fourth data field 73 of the data structure 66 is modified to include data identifying the most recently installed computer system 14, with the replacement task 140 then ending in step 158.

FIG. 6 is a flow chart of processes occurring during execution of the deployment task 160 scheduled for execution by the management server 18 in step 138 of the remote deployment application 58. After starting in step 162, the deployment task 160 proceeds to step 164, in which information identifying the computer system 14 that has just been installed, such as the WWN of the host bus adapter 26 within this computer system 14, is read. Next, in step 166, a file location within the data and instruction storage 62 not associated with another computer system 14 is established, being identified with a LUN for access over the Fibre Channel 17. Then, in step 170, the information read in step 164 and the LUN generated in to identify a file location in step 166 is written to provide a path through the Fibre Channel 17. For example, the WWN of the controller 60 of the storage server 15 and the LUN established for a portion of the data and instruction storage 62 in step 166 are written to the host bus adapter 26 of the computer system 14, while the WWN of the host bus adapter 26 is written to the controller 60.

Zoning may be implemented within the Fibre Channel Switch 19a to aid in preventing the use by any of the computer systems 14 of portions of the data and instruction storage 62 that are not assigned to the particular computer system 14. Thus, in step 172, a determination is made of whether zoning is enabled. If it is, in step 174, a zoning entry is written to the Fibre Channel Switch 19a including the WWN of the host bus adapter 26 of the computer system 14, the WWN of the controller 60 of the storage server 15, and the LUN of the portion of the data and instruction storage 62 now assigned to the computer system 14. In either case, in step 176, the operating system is loaded into the portion of the data and instruction storage 62 for which the new LUN has been established in step 166. Next, in step 178, the fourth data field 73 of the data structure 66 is modified to include data identifying the most recently installed computer system 14, before the deployment task ends in step 180.

While the invention has been described in its preferred form or embodiment with some degree of particularity, it is understood that this description has been given only by way of example, and that numerous details in the configuration of the system and in the arrangement of process steps can be made without departing from the spirit and scope of the invention, as described in the appended claims.

What is claimed is:

1. A method for selectively installing an operating system to be booted by a recently installed computer system, wherein the method comprises:
receiving a signal indicating that the recently installed computer system has been installed in a position providing access to remote data storage;
determining that the position has not previously been occupied by a formerly installed computer system; and
installing the operating system in a storage location to be accessed by the recently installed computer system within the remote data storage.

2. The method of claim 1, additionally comprising establishing a path for communications between the recently installed computer system and the storage location.

3. The method of claim 2, wherein the path for communications is established by writing information describing the storage location to the recently installed computer system and by writing information describing the recently installed computer system to a storage server controlling access to the remote data storage.

4. The method of claim 3, wherein
the position provides access to the remote data storage over a Fibre Channel,
the information describing the storage location includes a wwn and a logical unit number, and
the information describing the recently installed computer system includes a world wide name.

5. A method for selectively installing an operating system to be booted by a recently installed computer system, wherein the method comprises:
receiving a signal indicating that the recently installed computer system has been installed in a position providing access to remote data storage;
determining whether the position has previously been occupied by a formerly installed computer system;
in response to determining that the position has not previously been occupied by a formerly installed computer system, installing the operating system in a storage location within the remote data storage to be accessed by the recently installed computer system and establishing a path for communications between the recently installed computer system and the storage location; and
in response to determining that the position has previously been occupied by a formerly installed computer system, establishing a path for communications between the recently installed computer system and a location for storage in the remote data storage accessed by the formerly installed computer system.

6. The method of claim 5, wherein
the path for communications between the recently installed computer and the storage location is established by writing information describing the storage location to the recently installed computer system and by writing information describing the recently installed computer system to a storage server controlling access to the remote data storage, and
the path for communication between the recently installed computer system and the location for storage accessed by the formerly installed computer system is established by writing information describing the recently installed computer system to the storage server.

7. The method of claim 6, wherein
the position provides access to the remote data storage over a Fiber Channel,
the information describing the storage location includes a wwn and logical unit number, and
the information describing the recently installed computer system includes a world wide name.

8. The method of claim 6, additionally comprising:
determining whether the recently installed computer system has been previously installed in another position to access a previous location for storage within the remote data storage; and
in response to determining that the recently installed computer system has been previously installed in another position to access the previous location for storage, not changing the path for communication between the recently installed computer system and the previous location for storage.

9. The method of claim 8, additionally comprising maintaining a data structure storing information describing each computer system installed in a position providing access to the remote data storage, wherein information describing the recently installed computer system is compared with information stored within the data structure to determine whether the recently installed computer system has been previously installed in another position to access a previous location for storage within the remote data storage.

10. The method of claim 9, wherein
the position provides access to the remote data storage over a Fibre Channel,
the information describing each computer system includes a world wide name of the computer system, and
the information describing the recently installed computer system includes a world wide name of the recently installed computer system.

11. A system comprising:
a chassis including a plurality of computer system receiving positions and generating a signal indicating that a computer system is installed in one of the computer receiving positions;
first and second networks;
a storage server providing access to remote data storage over the first network from each of the computer receiving positions;
a management server, connected to the chassis and to the storage server over the second network, programmed to perform a method including steps of:
receiving a signal indicating that a recently installed computer system has been installed in a first position within the plurality of computer receiving positions;
determining whether the first position has previously been occupied by a formerly installed computer system;
in response to determining that the first position has not previously been occupied by a formerly installed computer system, installing the operating system in a storage location within the remote data storage to be accessed by the recently installed computer system and establishing a path for communications between the recently installed computer system and the storage location within the remote data storage; and
in response to determining that the first position has previously been occupied by a formerly installed computer system, establishing a path for communications between the recently installed computer system and a location for storage within the remote data storage accessed by the formerly installed computer system.

12. The system of claim 11, wherein
the path for communications between the recently installed computer and the storage location is established by writing information over the second network describing the storage location to the recently installed computer system and by writing information over the second network describing the recently installed computer system to the storage server, and
the path for communication between the recently installed computer system and the location for storage accessed by the formerly installed computer system is established by writing information over the second network describing the recently installed computer system to the storage server.

13. The system of claim 12, wherein
the first network includes a Fiber Channel,
the information describing the storage location includes a wwn and logical unit number, and
the information describing the recently installed computer system includes a world wide name.

14. The system of claim 11, wherein the method additionally comprises
determining whether the recently installed computer system has been previously installed in another of the computer receiving positions to access a previous location for storage within the remote data storage; and
in response to determining that the recently installed computer system has been previously installed in another of the computer receiving positions to access the previous location for storage, not changing the path for communication between the recently installed computer system and the previous location for storage.

15. The system of claim 14, wherein
the method additionally comprises maintaining a data structure storing information describing each computer system installed in a position within the plurality of computer positions, and
information describing the recently installed computer system is compared with information stored within the data structure to determine whether the recently installed computer system has been previously installed in another of the computer receiving positions to access a previous location for storage within the remote data storage.

16. The system of claim 15, wherein
the first network includes a Fibre Channel, and
the information describing each computer system installed in a position within the plurality of computer positions includes a world wide name.

17. A computer readable medium having computer executable instructions for performing a method comprising:
receiving a signal indicating that a recently installed computer system has been installed in a first position within a plurality of computer receiving positions having access to remote data storage;
determining whether the first position has previously been occupied by a formerly installed computer system;
in response to determining that the first position has not previously been occupied by a formerly installed computer system, establishing a path for communications between the recently installed computer system and the storage location within the remote data storage, and installing the operating system in a storage location within the remote data storage to be accessed by the recently installed computer system ; and
in response to determining that the first position has previously been occupied by a formerly installed computer system, establishing a path for communications between the recently installed computer system and a location for storage within the remote data storage accessed by the formerly installed computer system.

18. The computer readable medium of claim 17, wherein
the path for communications between the recently installed computer and the storage location is established by writing information describing the storage location to the recently installed computer system and by writing information describing the recently installed computer system to a storage server controlling access to the remote data storage, and
the path for communication between the recently installed computer system and the location for storage accessed by the formerly installed computer system is established by writing information describing the recently installed computer system to the storage server.

19. The computer readable medium of claim 18, wherein
the information describing the storage location includes a wwn and logical unit number, and
the information describing the recently installed computer system includes a world wide name.

20. The computer readable medium of claim 17, wherein the method additionally comprises
determining whether the recently installed computer system has been previously installed in another of the computer receiving positions to access a previous location for storage within the remote data storage; and
in response to determining that the recently installed computer system has been previously installed in another of the computer receiving positions to access the previous location for storage, not changing the path for communication between the recently installed computer system and the previous location for storage.

21. The computer readable medium of claim 20, wherein
the method additionally comprises maintaining a data structure storing information describing each computer system installed in a position within the plurality of computer positions, and
information describing the recently installed computer system is compared with information stored within the data structure to determine whether the recently installed computer system has been previously installed in another of the computer receiving positions to access a previous location for storage within the remote data storage.

22. The computer readable medium of claim 21, wherein the information describing each computer system installed in a position within the plurality of computer positions includes a world wide name.

23. A computer data signal embodied in a carrier wave having computer executable instructions for performing a method comprising:
receiving a signal indicating that a recently installed computer system has been installed in a first position within a plurality of computer receiving positions having access to remote data storage;
determining whether the first position has previously been occupied by a formerly installed computer system;
in response to determining that the first position has not previously been occupied by a formerly installed computer system, establishing a path for communications between the recently installed computer system and the storage location within the remote data storage and installing the operating system in a storage location within the remote data storage to be accessed by the recently installed computer system ; and
in response to determining that the first position has previously been occupied by a formerly installed computer system, establishing a path for communications between the recently installed computer system and a location for storage within the remote data storage accessed by the formerly installed computer system.

24. The computer data signal of claim 23, wherein
the path for communications between the recently installed computer and the storage location is established by writing information describing the storage location to the recently installed computer system and by writing information describing the recently installed computer system to a storage server controlling access to the remote data storage, and
the path for communication between the recently installed computer system and the location for storage accessed by the formerly installed computer system is established by writing information describing the recently installed computer system to the storage server.

25. The computer data signal of claim 24, wherein
the information describing the storage location includes a wwn and logical unit number, and
the information describing the recently installed computer system includes a world wide name.

26. The computer data signal of claim 23, wherein the method additionally comprises
determining whether the recently installed computer system has been previously installed in another of the computer receiving positions to access a previous location for storage within the remote data storage; and
in response to determining that the recently installed computer system has been previously installed in another of the computer receiving positions to access the previous location for storage, not changing the path for communication between the recently installed computer system and the previous location for storage.

27. The computer data signal of claim 26, wherein
the method additionally comprises maintaining a data structure storing information describing each computer system installed in a position within the plurality of computer positions, and
information describing the recently installed computer system is compared with information stored within the data structure to determine whether the recently installed computer system has been previously installed in another of the computer receiving positions to access a previous location for storage within the remote data storage.

28. The computer data signal of claim 27, wherein the information describing each computer system installed in a position within the plurality of computer positions includes a world wide name.
